(19) United States
(12) Patent Application Publication
(10) Pub. No.: US 2010/0027270 A1
(43) Pub. Date: Feb. 4, 2010

(54) SAFE AND HIGH-BRIGHTNESS LED LAMP

(76) Inventors: Yao Hui Huang, Taipei (TW); Guan Ming Chen, Banciao City (TW)

Correspondence Address: SINORICA, LLC, 2275 Research Blvd., Suite 500, ROCKVILLE, MD, 20850, US

(21) Appl. No.: 12/185,155

(22) Filed: Aug. 4, 2008

(51) Int. Cl. F21V 7/00; F21V 29/02

(52) U.S. Cl. 362/310; 362/373

(57) ABSTRACT

A safe and high-brightness LED lamp consists of a lampshade, a bulb mounting base, an LED module and a circuit board. The lampshade and bulb mounting base construct an inner space, which is allowable to store said LED module; the LED module consists of a heat-radiating block, an LED lamp panel and a reflective wall, where such LED lamp panel can be flat nestled up against the heat-radiating block at one end. Moreover, such reflective wall can be coupled with the LED lamp so that the said inner space can be partitioned into one light source refractive space and one flowing space for airflow thereof. Furthermore, an electrical fan is installed outside the heat-radiating block. Thereby, while light is being refracted and diffused via reflective wall into the light source refractive space in lampshade, it will then be refracted and diffused once more, and under this circumstance, not only the light will become more uniform with higher brightness, but also it will improve the heat radiation efficiency, and thus, resulting in a longer service life for such LED lamp while utilizing the said flowing space for airflow to guide the air blown by the fan.

### BACKGROUND OF THE INVENTION

1. Field of the Invention

The present invention relates generally to a safe and high-brightness LED lamp, consisting of one lampshade, one bulb mounting base, one LED module and one circuit board, where the said lampshade and said bulb mounting base is constructing an inner space, which is allowable to store said LED module after assembly.

2. The Prior Arts

LED has several advantages, such as, energy-saving, longer service life, mercury-free, high color regeneration etc. as well as environmental protection, moreover, it even has a very high illuminating uniformity and sufficient light flux, therefore, it can be extensively applied to various fields, for instance: Traffic signals, large advertizing board, flashlight, indoor illumination etc.

However, while using LED bulb as a light source, its lightness could be limited due to the insufficient quantity of light bulbs, but if using too many light bulbs, then the electricity consumption will become a serious problem in addition to the high temperature during operating period which can even decreasing the lightness of LED lamp and furthermore shortening the service life of such LED lamp consequently.

### SUMMARY OF THE INVENTION

The present invention relates to a safe and high-brightness LED lamp, which consists of a lampshade, a bulb mounting base, a LED module and a circuit board, where after combining said lampshade and said bulb mounting base, it will be able to construct an inner space, which is allowable to store said LED module and circuit board, wherein, the said LED module consists of a heat-radiating block, an LED lamp panel and a reflective wall, where said LED lamp panel can be flat nestled up against said heat-radiating block at one end, moreover, such reflective wall can be coupled with the LED lamp so that the reflective wall is able to partition the said inner space into one light source refractive space and one flowing space for airflow thereof. Furthermore, there is an electrical fan installed outside the thermal conductivity pillar of said heat-radiating block. Thereby, while LED light is firstly being refracted and diffused via the reflective wall into the light source refractive space in lampshade it will become more uniform, and again while it is secondly being refracted and diffused by the light diffusing layer of said lampshade, then it not only will become an uniform light source with higher brightness, but also it will improve the heat radiation efficiency, and thus, resulting in a longer service life for such LED lamp while utilizing the said flowing space for airflow to guide the heat energy blown by the electric fan directly.

The primary objective of the present invention lies in providing a kind of bulb structure that utilize the reflective wall installed at circumference of a LED lamp to firstly refract and diffuse LED light into a lampshade, and then such LED light will secondly be refracted and diffused, through light source refractive space, by the diffusing and reflecting layer positioned at inner layer of said lampshade in order to generate an uniform LED light along with high brightness.

The secondary objective of the present invention is to provide a kind of bulb that utilizes a heat-radiating block to contact with LED lamp panel to absorbing a great deal of heat energy, and also utilizing a heat-radiating fan to directly guide heat energy with a flowing space for airflow, so that heat energy will be rapidly diffused into atmosphere via heat radiating hole of bulb mounting base and hence prolonging the service life of said bulb by the method of decreasing the temperature of LED module thereof.

Another objective of the present invention is to provide a kind of bulb that cab be applied to the existing production equipments, so that it can reduce the production costs with a wider field of application.

Again, one more objective of the present invention is to provide a single LED lamp with a higher illumination efficiency as well as lower consumption of electricity.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a stereographic exploded view of the present invention;

FIG. 2 is a stereographic assembly view of the present invention;

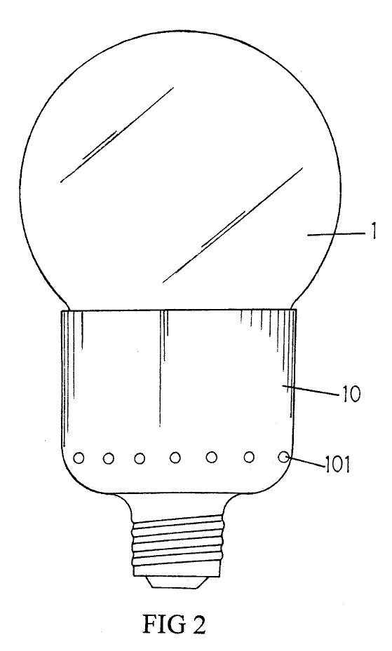

FIG. 3 is an assembly exploded view of the present invention;

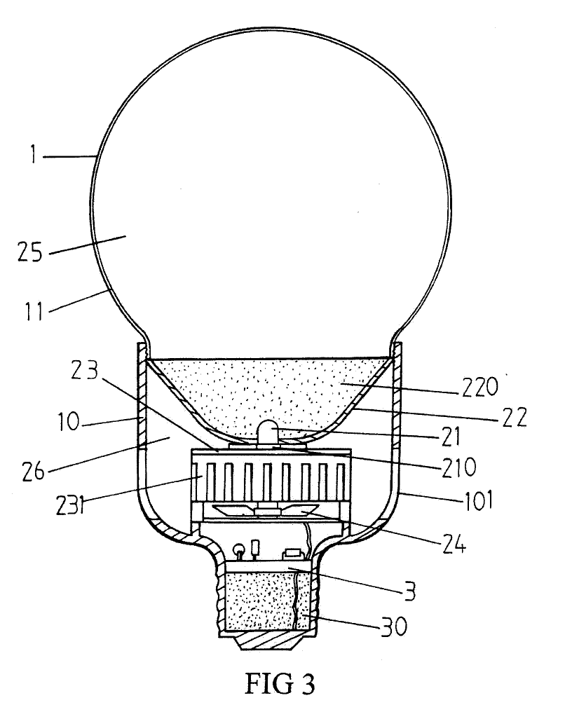

FIG. 4 is a schematic view showing operation function of the present invention;

FIG. 5 is a schematic view showing heat radiating direction of the present invention;

FIG. 6 is a schematic view showing heat radiating operation of the present invention;

FIG. 7 is a schematic view showing another preferred embodiment of reflective wall in accordance with the present invention;

FIG. 8 is a schematic view showing another preferred embodiment in accordance with the present invention;

FIG. 9 is a schematic view showing heat radiating operation of another preferred embodiment in accordance with the present invention.

### DETAILED DESCRIPTION OF THE PREFERRED EMBODIMENT

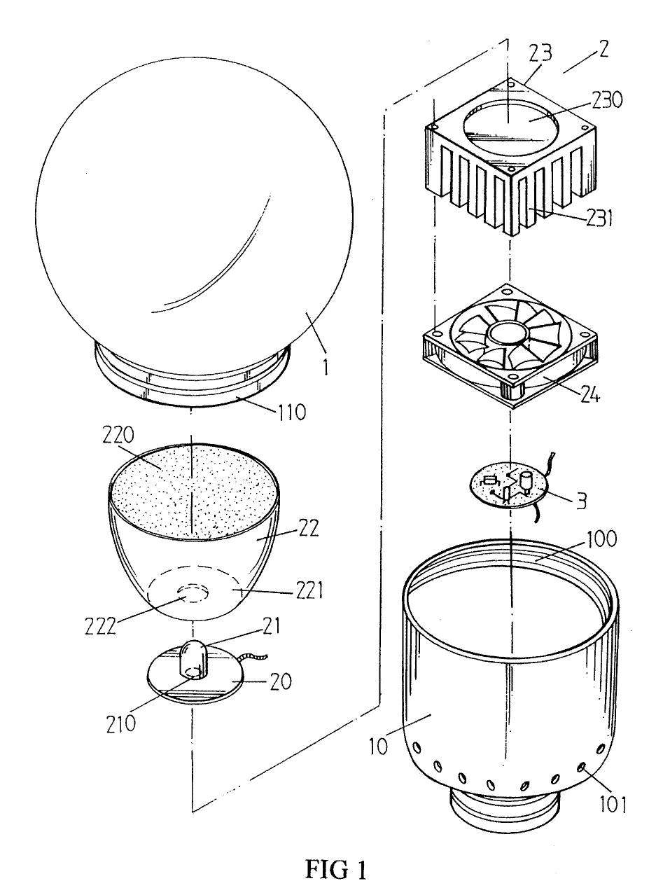

With reference to FIG. 1, 2, and 3 respectively, wherein, the preferred embodiment of the present invention is being represented with a bulb structure, which primarily consists of one lampshade 1, one bulb mounting base 10, one LED module 2 and one circuit board 31, wherein, the lampshade 1 has a hollow structure of shade body with an opening, where its inner layer is being adhered to a light diffusing layer 11, and the outer edge of opening of said lampshade has been constructed as a threaded portion 110 which can be coupled together with internal threads 100 positioned at opening of bulb mounting base 10 and constructing an inner space thereof. The said inner space can store both said LED module 2 and one circuit board 3, wherein, said LED module 2 consists of LED lamp panel 20, reflective wall 22, heat-radiating block 23, and heat-radiating fan 24; moreover, the said LED lamp panel 20 is installed with a LED lamp 21, and the end-contact 210 of said LED lamp 21 is being flat nestled up against a plane 230 on the heat-radiating block 23, and also, it is available to apply thermal conductivity paste onto the connection surface between said LED lamp panel 20 and said heat-radiating block in order to increasing the contacting area and its thermal conductivity as well. Additionally, the LED lamp 21 is enclosed by said reflective wall 22, and the said reflective wall 22 belongs to a multiple-layer type structure, where its outer layer is made from aluminum material, and its inner layer with an arc surface is made from reflective film 220, which has been designed as a funnel structure, and thereat, an opening 222 is equipped at the bottom surface 221 which allows the said LED lamp 21 to be installed inside the reflective wall 22; furthermore, the edge of opening of said reflective wall 22 is being flat nestled up against internal wall of bulb mounting base 10 and in this way, it is able to partition the inner space where into two enclosed spaces, such as, one light source refractive space 25 and one flowing space for airflow 26; again, a heat-radiating fan 24 is being installed at thermal conductivity pillar 231 extending from another end of heat-radiating block 23, and hereby, it will be able to make air volume being providing directly onto the thermal conductivity pillar 231 of heat-radiating block 23, so that heat energy accumulated by thermal conductivity pillar 231 can be guided by the flowing space for airflow 26 and being rapidly diffused to atmosphere through heat radiating hole 101 and hence decreasing temperature accordingly; in addition, the circuit board 3 is being adhered to the lower end of bulb mounting base 10 with non-conductive glue 30 so that it can connect to power source contact and hence constructing an electrically conductive path thereof, and in this way, it will be able to transfer AC power supplied from outside bulb mounting base 10 directly into DC power and supplying to both the LED lamp panel 20 and heat-radiating fan 24 via circuit board 3 to illuminate LED lamp, meanwhile activating heat-radiating fan 24 to blowing the heat away.

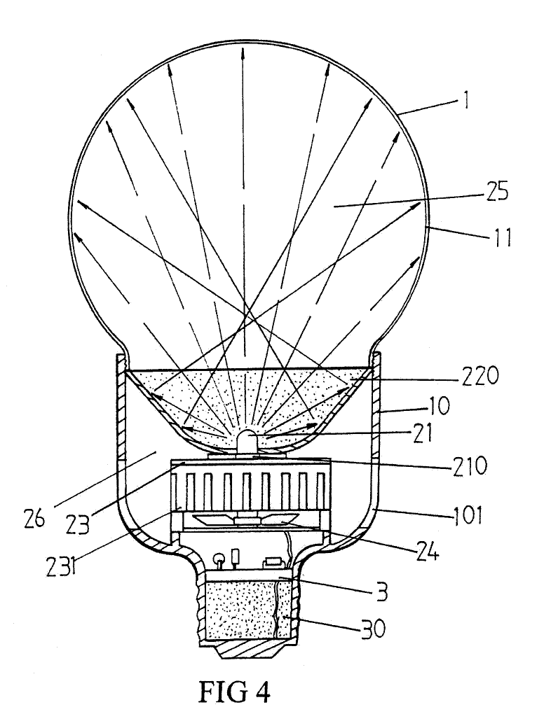

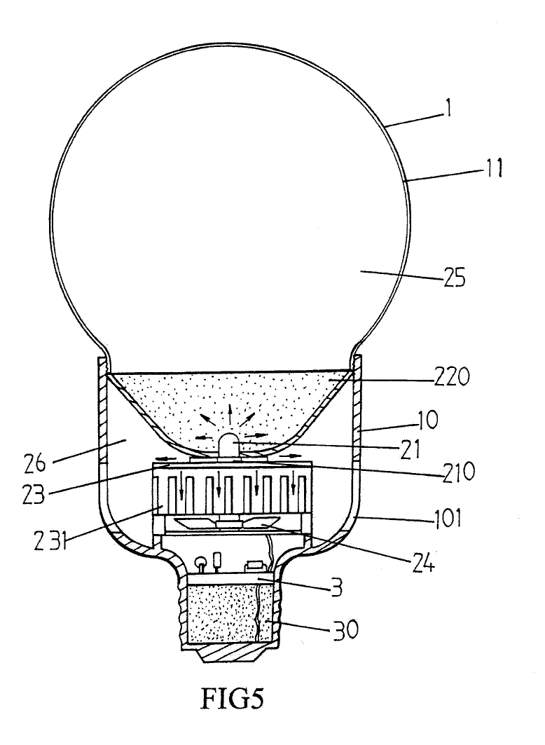

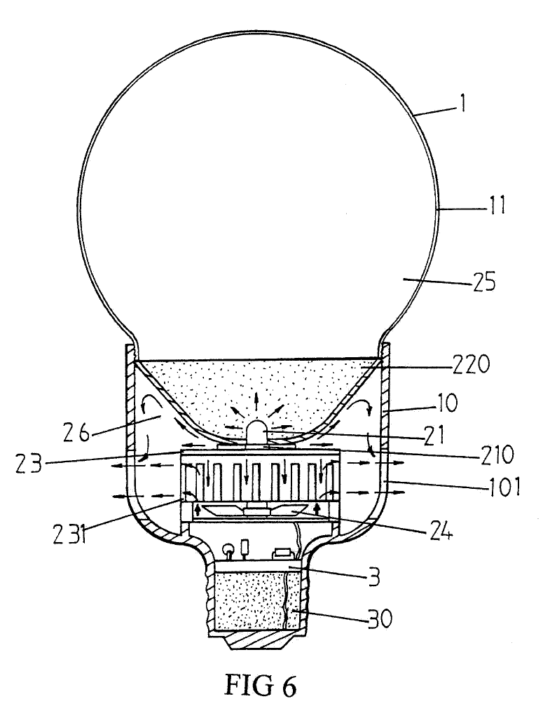

With reference to FIG. 4, after illuminating the LED lamp 21, the light source will firstly be uniformly reflected and diffused by a layer of reflective film 220 covered on internal surface of said reflective wall 22 into the light diffusing layer 11 positioned at inner layer of said lampshade 1, and then it will secondly be refracted and diffused by light diffusing layer 11 as well as being effected by enclosed space of (light source refractive space 25 at the same time, and hence, enhancing its brightness by concentrating light of LED lamp 21. While referring to FIG. 5 and 6, it shows heat energy generated by operating LED lamp 21 will be conducted, through plane of heat-radiating block 23, to each thermal conductivity pillar 231 and aluminum metal positioned at outer layer of said reflective wall 22, and then it is able to utilize a heat-radiating fan 24 to blowing air directly to each thermal conductivity pillar 231 of heat-radiating block 23 so as to guide heat energy with flowing space for airflow 26 and hence rapidly diffusing heat energy to atmosphere through heat radiating hole 101, and in this way, it will be able to protect the said LED lamp 21 by decreasing the high temperature generated inside the said LED lamp 21 thereof.

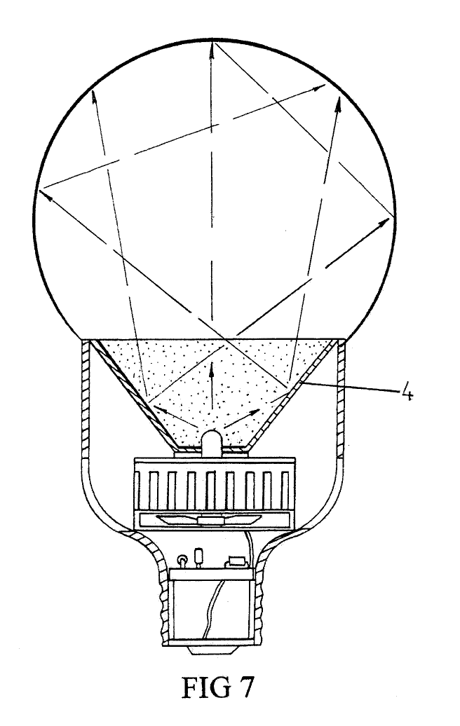

While referring to FIG. 7, it shows another preferred embodiment of reflective wall 22 in accordance with the present invention, wherein the inclined plane 4 of said reflective wall 22 has been designed as a funnel shaped.

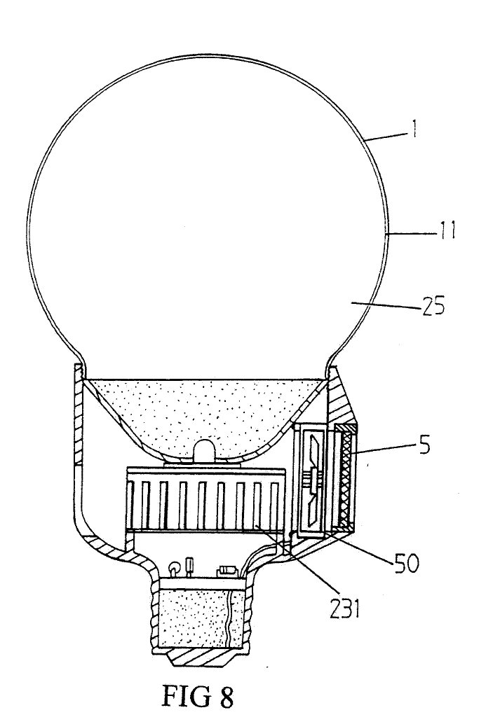

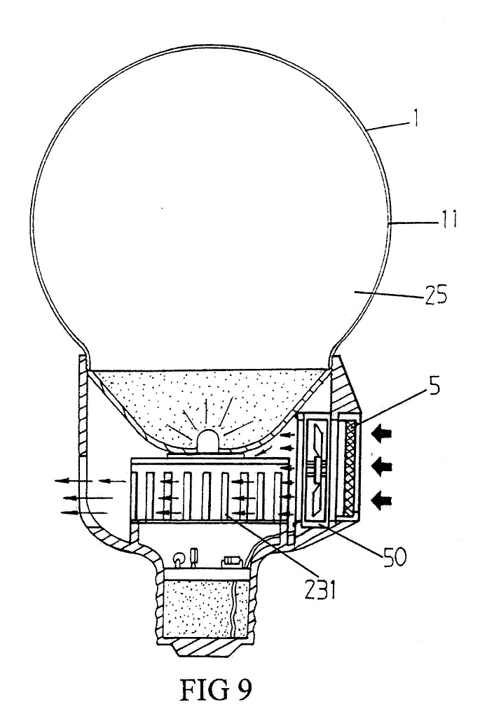

As shown in FIG. 8 and 9, it is a schematic view of another preferred embodiment in accordance with the present invention, wherein, it primarily installs the filter mesh 5 and heat-radiating fan 50 outside heat-radiating block 23, so that cool air can be filtered firstly with movable type filter mesh 5 via a heat-radiating fan 50 and then the clean air will be blown directly to thermal conductivity pillar 231 and in this way the heat energy will be guided by the flowing space for airflow 26 and rapidly diffused into atmosphere via heat radiating hole 101 and hence rapidly decreasing the high temperature generated inside LED lamp 21 and thus prolonging the service life of said internal components accordingly.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A safe and high-brightness LED lamp, which consists of a lampshade, a bulb mounting base, a LED module and a circuit board, wherein,
the lampshade is a hollow type shade body with one opening and has a diffusing and reflecting layer adhered to inner surface of said shade body; while combining the opening of said hollow type shade body together with the opening of bulb mounting base, it will construct an inner space which can store the said LED module;
the LED module consists of one heat-radiating block, an LED lamp panel and a reflective wall, said heat-radiating block has a flat surface which makes LED lamp panel allowable to be flat nestled up against said reflective wall, so that it will make the reflective wall to enclose a lamp panel of said LED lamp with its wall, and meanwhile making said reflective wall to partition said inner space where into one light source refractive space and one flowing space for airflow; a heat-radiating fan is fastened outside the heat-radiating pillar of the heat-radiating block;
the circuit board is being fastened at a lower end of said bulb mounting base so as to connect the power source contact and hence generating an electrically conductive path, and the circuit board connects to both the heat-radiating fan and the LED lamp panel respectively; and
while light is being refracted and diffused via reflective wall into the light source refractive space in lampshade, it will then be refracted and diffused once more, and under this circumstance, not only the light will become more uniform with higher brightness, but also it will improve the heat radiation efficiency, and thus, resulting in a longer service life for such LED lamp while utilizing the said flowing space for airflow to guide the air blown by the fan.

2. The safe and high-brightness LED lamp as claimed in claim 1, wherein there is an vent hole being opened at external edge of said bulb mounting base which is correspondingly to its heat-radiating fan.

3. The safe and high-brightness LED lamp as claimed in claim 1, wherein the inner layer of reflective wall of said LED module is adhered with a reflecting film, where the external layer of said reflective wall is made from aluminum material.

4. The safe and high-brightness LED lamp as claimed in claim 1, wherein the reflective wall of said LED module has a funnel shaped structure.

5. The safe and high-brightness LED lamp as claimed in claim 1, wherein there is filter mesh additionally installed at the heat-radiating fan positioned outside the heat-radiating pillar of heat-radiating block.

6. The safe and high-brightness LED lamp as claimed in claim 3, wherein said reflective wall is an inclined plane structure.

7. The safe and high-brightness LED lamp as claimed in claim 3, wherein said reflective wall is an arc surface structure.

8. The safe and high-brightness LED lamp as claimed in claim 3, wherein the size of the opened edge of said reflective wall is smaller than inner diameter of said bulb mounting base.
